(19) United States
(12) Patent Application Publication
(10) Pub. No.: US 2025/0354857 A1
(43) Pub. Date: Nov. 20, 2025

(54) System And Method For Measuring Oscillations And Characterizing Surface Geometry Of Reflective Surfaces By Reflecting Light Onto An Image Capture Screen

(71) Applicant: ConcurrentData, Inc., Brighton, MI (US)

(72) Inventors: Edward J. GILLIS, Ann Arbor, MI (US); Mark RAUCHFUSS, Birmingham, MI (US)

(73) Assignee: ConcurrentData, Inc., Brighton, MI (US)

(21) Appl. No.: 19/211,451

(22) Filed: May 19, 2025

Related U.S. Application Data
(60) Provisional application No. 63/649,516, filed on May 20, 2024.

(51) Int. Cl. G01H 9/00

(52) U.S. Cl. CPC G01H 9/00

(57) ABSTRACT

A non-contact method is presented for measuring vibrations on a highly reflective surface of an object. The method includes: projecting focused light towards an area of interest on a surface of an object; receiving the light reflected by the area of interest on an image capture screen, where the image capture screen is configured to diffuse the light incident thereon; capturing an image of the light on the image capture screen using a detector; determining change in position of the image on the detector over time; and calculating a series of changes in the surface angle and a series of vertical displacements of the surface from the change in position of the image and using triangulation.

### CROSS-REFERENCE TO RELATED APPLICATIONS

This application claims the benefit and priority of U.S. application No. 63/649,516, filed May 20, 2024. The entire disclosure of the above application is incorporated herein by reference.

### FIELD

The present disclosure relates to a non-contact and minimally invasive method for measuring vibration or oscillations on a surface of an object.

### BACKGROUND

Conventional methods of measuring surface oscillations on the surface of an object or structure under test rely upon physically attaching piezoelectric sensors to the surface of the object. There are a number of undesirable effects and dependencies resulting from physical attachment of these sensors onto the surface of the object, which affect the physical and acoustical behavior of the surface and can result in inaccurate and unreliable observation of surface oscillations. Therefore, it is desirable to develop a non-contact technique for measuring vibrations or oscillations on a surface of an object.

An alternate means for measuring vibrations or oscillations is to illuminate a sufficient number of localized regions with narrow light beams and to determine the spatial and temporal correlations of changes of position and orientation of the surface at those locations.

Surfaces that are highly reflective (“specularly reflective”) reflect the incident light in a very narrow beam at an angle that is sensitively dependent on both the position of the illuminated spots and on the rapidly varying angle of the surface at those locations. This is a consequence of the principle that the angle of reflection equals the angle of incidence. Since the highest speed detectors are relatively small, it is difficult to intercept a light beam reflected directly from such a surface. However, if the light beam is first intercepted by an image capture screen that is either diffusively reflecting or diffusively translucent, then motion of the target surface can be tracked at high frequency by tracking the motion of the illuminated spot on the secondary surface. Because the light from the illuminated spot spreads in all directions from such a surface, the motion of the spot can be tracked from almost any viewing angle by detection devices that are placed in a position to observe the illuminated spot on the secondary surface. The amplitude and frequency of the oscillations of the target surface, and changes in the surface angle generated by the oscillations can then be determined by straightforward mathematical techniques applied to the variations in the signal as measured by the detecting devices. These techniques are described below.

The use of a secondary surface as a means of tracking vibrations has several advantages. The structures being investigated are subject to flexural stresses, and these stresses are one of the chief causes of weakening or failure of the structure. Hence, the degree of flexing is of primary interest in the study of the behavior of the target structures. The degree of flexing can be determined by measuring the surface angles at nearby points on the surface. By placing the secondary surface at an optimum distance from the target surface it is possible to substantially increase the measurement resolution of the surface angle. The comparison of these adjacent measurements also allows one to determine the wavelength of the oscillations and the direction in which they are propagating. Together with the change in the surface angle measurements one can derive the amplitude of the oscillations. Since the frequency is determined by successive measurements, this provides a method to compute the acceleration.

Terms, symbols, and abbreviations below refer to the structures and quantities of interest, and they also define the coordinate system that is used in describing the measurements and calculations presented below; they are used in the following drawings, detailed description, and claims. In general, distinct illuminated spots will have distinct coordinate systems.
Origin: O position of illuminated spot on target surface under not excited conditions;
Principal plane of the target surface: Plane that is tangent to target surface at the location where the incident beam strikes the target surface under not excited conditions
z-axis: direction that is perpendicular to the principal plane of the target surface
x-axis: one of the directions lying in the principal plane of the target surface
y-axis: the direction in the principal plane of the target surface that is perpendicular to the x-axis
Surface angle: the angle between the tangent plane of the target surface when the surface is not excited and the tangent plane of the target surface when the surface is observed by the observing system, whether the surface is excited or not excited at the time of observation. The angle is measured in both the x and y directions.
Theta: θ angle between incident beam and the z-axis
Alpha: α angle at which excited surface is deflected from the not excited principal plane as measured from x-axis
   Beta: β angle at which excited surface is deflected from the not excited principal plane as measured from y-axis
Delta: δ displacement of target surface along z-axis
Delta prime: δ′ additional displacement in the z-direction of the position where the incident light beam intersects the target surface due to the change in the surface angle of the target surface
z₀: distance between target surface and detector screen along z-axis under not excited conditions
Delta_x: δx displacement in x-direction of illuminated spot from origin resulting from change in the surface angle, alpha
Delta_y: δy displacement in y-direction of illuminated spot from origin resulting from change in the surface angle, beta
x_{d}: distance from z-axis in x-direction of reflected image on detector screen
y_{d}: distance from z-axis in y-direction of reflected image on detector screen

For the small surface angles (much less than 90 degrees) that will be generated and observed there is a one-to-one correspondence between the angle and the tangent of the angle. This is also true for the cotangent. In most of the equations presented below it is the tangent of the angle that is used to calculate the relevant quantities.
Tangent of theta: tan ⊖ Abbreviation: H
Tangent of alpha: tan α Abbreviation: A
Tangent of beta: tan β Abbreviation: B

The following trigonometric identities are also used:

tan(α+/−β)=(tan α+/−tan β)/(1−/+tan α*tan β);

cot(α+/−β)=(cot α−/+cot β)(1+/−cot α*cot β)

Additional terminology will be introduced as needed.

This section provides background information related to the present disclosure which is not necessarily prior art.

### SUMMARY

This section provides a general summary of the disclosure, and is not a comprehensive disclosure of its full scope or all of its features.

In one aspect, a non-contact method is presented for measuring vibrations on a highly reflective surface of an object. The method includes: projecting, by a light source, beam of light towards an area of interest on a surface of an object; receiving, by an image capture screen, the light reflected by the area of interest on the surface of the object, where the image capture screen is configured to diffuse the light incident thereon; capturing, by a detector, an image of the light on the image capture screen; determining, by a processor, change in position of the image on the detector over time, where the processor is interfaced with the detector; and calculating, by the processor, a series of changes in the surface angle and a series of vertical displacements of the surface from the change in position of the image and using triangulation. Depending on the optical arrangement, the image capture screen may be reflective or translucent.

In one embodiment, the series of changes in the surface angle are calculated according to: A=δx_{d}/2z₀ and B=δy_{d}/2z₀, where the x axis and the y axis define a plane which is parallel to the surface of the object; A and B are tangents of the angles of deviation in the x and y directions respectively; z₀, is distance between the surface of the object when not excited and the image capture screen; and δx_{d} and δy_{d} are changes in position of the image differences in x and y directions from its equilibrium location.

From the series of changes in the surface angle and the series of vertical displacements, a characteristic or attribute of a wave propagating along the surface of the object can be determined. Characteristic of the propagating wave include but are not limited to a direction, a wavelength, an amplitude, a frequency or an induced shear strain of the wave propagating along the surface.

Frequency of the wave propagating along the surface can be determined by measuring time between successive measurements of maxima of the tangents of the changes in the surface angle in the x and y directions or by performing a Fourier analysis on the series of measurements of changes in the surface angle.

Wavelength of the wave propagating along the surface can be determined using difference between measurements of the tangents of the changes in the surface angle at two points of observation.

Speed of the wave propagating along the surface can be calculated by multiplying the wavelength of the wave by the frequency of the wave.

Amplitude of the wave propagating along the surface can be calculated using the wavelength of the wave propagating along the surface and tangent of the changes in the surface angle.

Direction of wave propagating across the surface can be calculated by vector addition of tangents of surface angle in two non-parallel directions in a plane which is parallel to the surface of the object.

In another aspect, the non-contact method for measuring vibration on a surface of an object may employ two or more light sources projecting light towards the same point of interest on a surface of an object. The method includes: receiving the light reflected by the point of interest on an image capture screen, where the image capture screen is configured to diffuse the light incident thereon; capturing an image of light on the image capture screen using two or more detectors, where each detector of the two or more detectors captures light from a corresponding one of the two or more light sources; from the light captured by the two or more detectors, determining, by a processor, change in position of the image on each detector over time, where the processor is interfaced with each of the two or more detectors; from the change in position of the image on each detector of the two or more detectors, calculating, by the processor, a series of deflection angles of the surface at the point of intertest about an x axis using triangulation; and from the change in position of the image on each detector of the two or more detectors, calculating, by the processor, a series of deflection angles of the surface at the point of interest about y axis using triangulation, where the x axis and the y axis define a plane which is parallel to surface of the object.

From the series of deflection angle (about the x and y axis), characteristic of a wave propagating along the surface of the object can be determined including but are not limited to a direction, a wavelength, an amplitude, a frequency or an induced shear strain of the wave propagating along the surface.

In yet another aspect, the non-contact method for measuring vibration on a surface of an object may employ two or more light sources projecting light towards different points of interest on a surface of an object. The method includes: receiving the light reflected by the at least two points of interest on an image capture screen, where the image capture screen is configured to diffuse the light incident thereon; capturing an image of light on the image capture screen using two or more detectors, where each detector of the two or more detectors captures light from a corresponding one of the two or more light sources; for each of the at least two points of interest, determining, by a processor, change in position of the image from the light captured by each detector over time, where the processor is interfaced with each of the two or more detectors; from the change in position of the image on each detector of the two or more detectors, calculating, by the processor, a series of deflection angles of the surface at each of the at least two points of intertest about an x axis using triangulation; and from the change in position of the image on each detector of the two or more detectors, calculating, by the processor, a series of deflection angles of the surface at each of the at least two points of interest about y axis using triangulation, where the x axis and the y axis define a plane which is parallel to surface of the object.

From the series of deflection angles (about the x and y axis), characteristic of a wave propagating along the surface of the object can be determined including but are not limited to a direction, a wavelength, an amplitude, a frequency or an induced shear strain of the wave propagating along the surface.

Additionally, a system is presented for measuring vibration on a surface of an object. The system includes at least one light source; an image capture screen, a detector and a processor. The light source projects beam of light towards an area of interest on a surface of an object. The image capture screen is configured to receive the light reflected by the area of interest on the surface of the object and diffuse the light incident thereon. The detector captures an image of the light on the image capture screen. The processor is interfaced with the detector. The processor determines change in position of the image on the detector over time; and calculates a series of changes in the surface angle and a series of vertical displacements of the surface from the change in position of the image.

In some embodiments, the system employs two or more light sources projecting light towards the same point of interest on a surface of an object. In other embodiments, the system employs two or more light sources projecting light towards different points of interest on a surface of an object.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is a diagram illustrating the reflection of an incident light beam 8 from a target surface 10 under not excited conditions. The angle of incidence, θ, is equal to the angle of reflection. The position of the illuminated spot on the secondary diffusively reflecting or diffusively translucent image capture screen is determined by the angle, θ, and by the distance between the target surface and image capture screen. For purposes of illustration the target surface is depicted as a plane although the surface can be curved.

FIG. 1B is a diagram illustrating the vertical displacement and change in the surface angle of a target surface around the location at which an incident light beam is directed; the displacement and change in the surface angle are caused by vibrations propagating across the target surface. The surface angle and displacement cause a change in the location of the illuminated spot on the image capture screen.

FIG. 1C shows a more detailed view of the highlighted area in FIG. 1B with labels for the angles and displacements that used in the equations below.

FIG. 2A is a diagram depicting the variations in vertical displacement and change in the surface angle at nearby points associated with the curvature of the surface that is induced by vibrations propagating across the target surface.

FIG. 2B shows the xₐ-yₐ coordinate system projected onto the image capture screen with the relative positions of the illuminated spots when the target surface is not excited and when it is excited.

FIG. 3 depicts a detector and the associated lens placed at position to observe the location of the image formed by the reflected light beam on the surface of the image capture screen.

Corresponding reference numerals indicate corresponding parts throughout the several views of the drawings.

### DETAILED DESCRIPTION

Example embodiments will now be described more fully with reference to the accompanying drawings. Some terms used throughout this disclosure are defined as follows. Vertical is to be understood as the direction that is perpendicular to the principal plane of the target surface where this direction is also designated as being parallel to the z-axis. The principal plane is defined as the plane that is most closely parallel to the general orientation of the surface. For example, the principal plane of a perfectly flat surface would be the plane in which that surface lies, such that the coordinate axes for the principal plane are labeled ‘x’ and ‘y’.

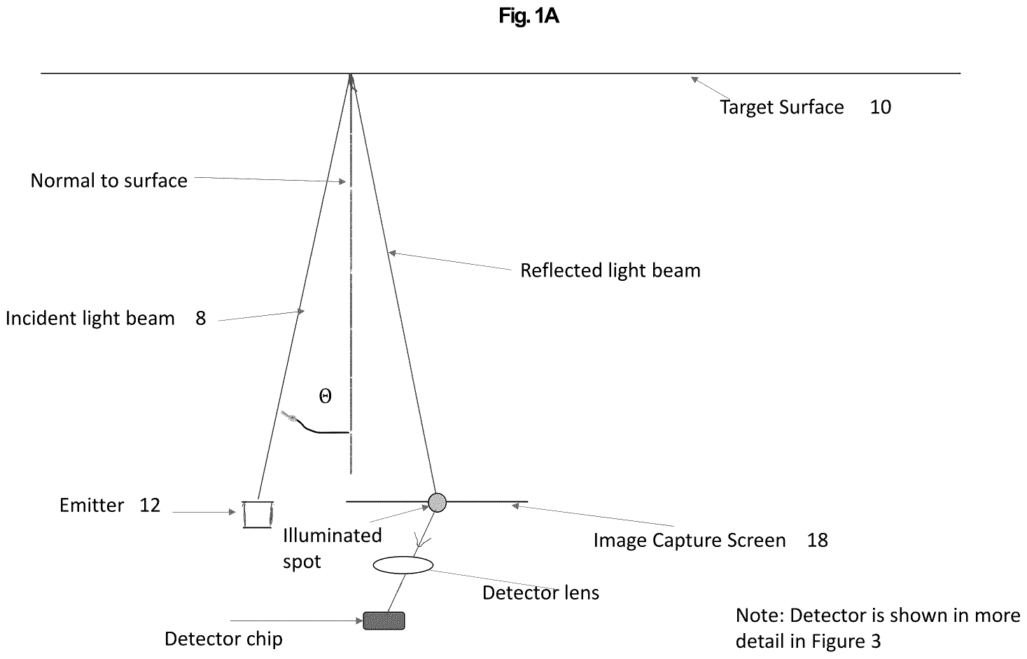

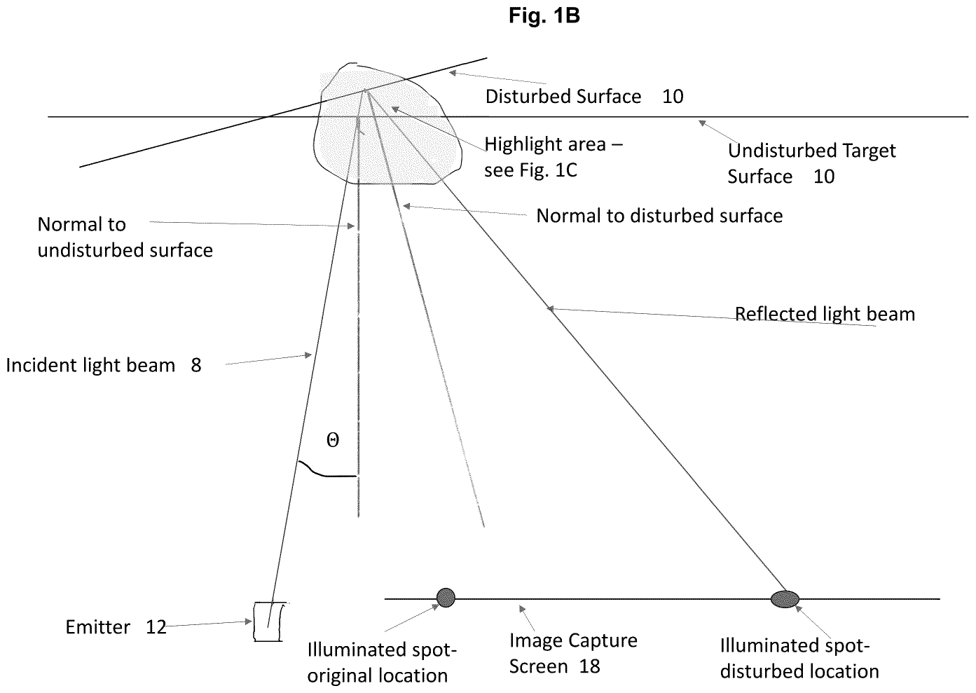

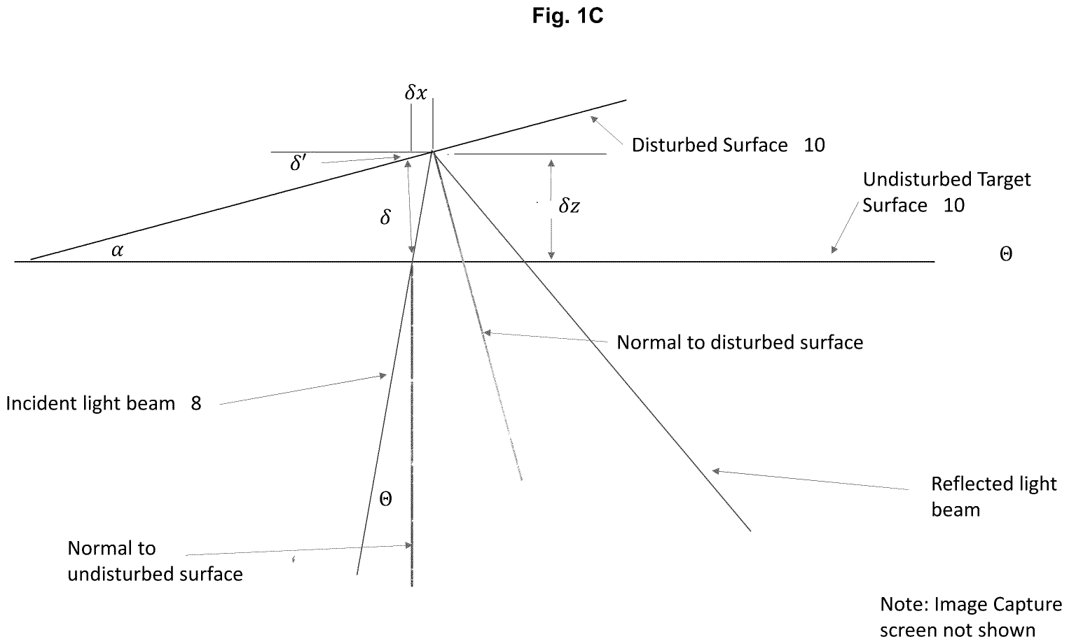

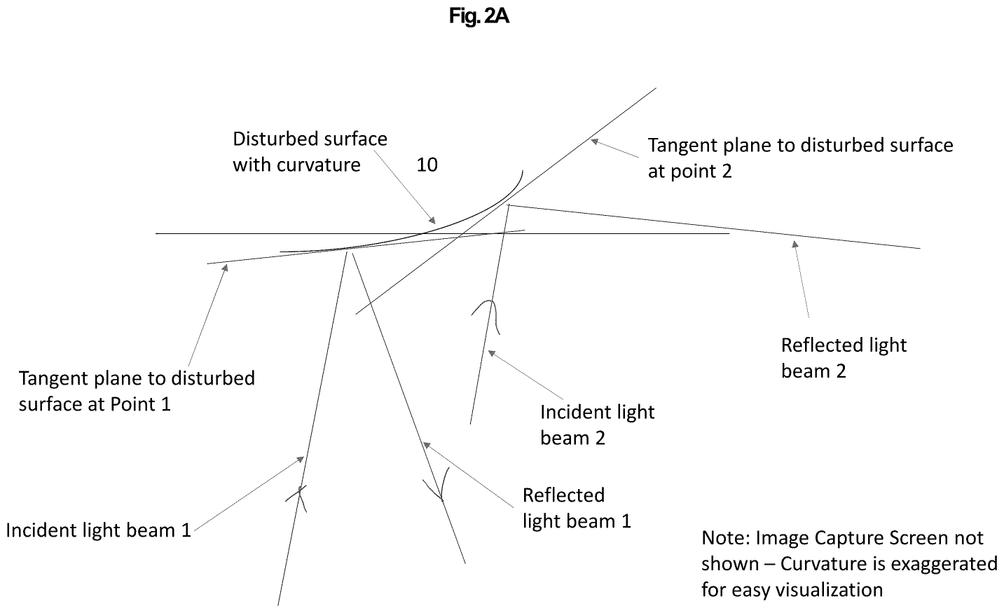

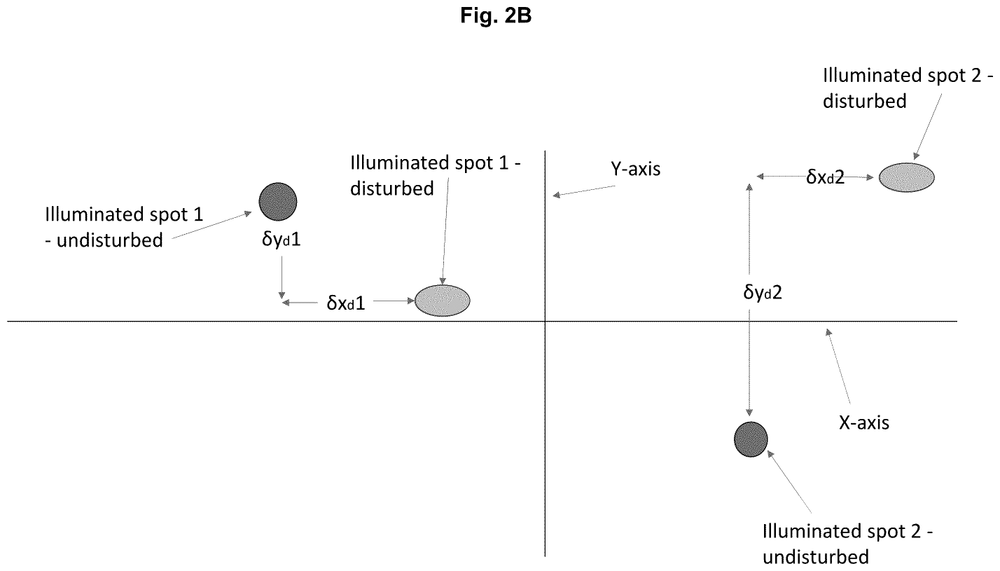

FIGS. 1A, 1B, 1C, 2A, and 2B illustrate a non-contact technique for measuring vibrations (or oscillations) on a highly reflective surface 10 of an object. Light is projected by a light source 12 along a projection axis 8 at an angle, θ, toward a point of interest on a surface 10 of the object. Light is reflected by the surface in a very narrow beam toward an image capture screen 18 shown at the bottom of the figures. Of note, the image capture screen is configured to diffuse the light incident thereon. In an example embodiment, the image capture screen is a front or back lighted projection screen found, for exampling in theaters. Other types of materials for constructing the image capture screen are contemplated by this disclosure. may be used to

Depending on the optical arrangement, the image capture screen may be translucent as seen in FIG. 1A. In this arrangement, light reflected from the surface 10 of the object impinges onto a surface of the image capture screen and the image of the light is captured by a detector on an opposing side of the image capture screen. Alternatively, the image capture screen may be reflective. In this arrangement, light reflected from the surface of the object impinges on a surface of the image capture screen and the image of the light is captured by a detector positioned on the same side of the image capture screen as the object.

The position of the image formed when the reflected beam strikes the image capture screen 18 depends primarily on the angle of deflection. The position depends to a less extent on the displacement in the z-direction of the target surface from its equilibrium position caused by vibrations propagating across the target surface. This position also depends on the angle, θ, at which the incident beam from the light source is directed at the target surface. This angle is measured relative to the z-axis, which is in the direction substantially perpendicular to the primary plane of the target surface. The change in the surface angle has two components: α, the angle between target surface and x-axis, measured in the y-z plane, and β, the angle between target surface and y-axis, measured in the x-z plane.

Measurements are made with optical components, such as lenses or diffraction gratings, that focus the light from the spot on the image capture screen onto a detector or detectors. In order to report oscillations of the surface, the light detector 14 is configured to capture changes in light position at more than 40,000 frames per second. In an example embodiment, the light detector is clocked at 160,000 frames per second. While a single detector is shown, two or more detectors are contemplated in different embodiments. The detector may be a charge-coupled device (CCD), a CMOS chip, or other similar device placed at a position to observe the location of the image formed by the reflected light beam on the image capture screen.

To determine the surface angle and the vertical displacement, the position and movement of the image on the image capture screen must be tracked. The following derivation and equations show how the position of the image is determined by the surface angle and vertical displacement (along with the angle of the incident light beam on the target surface). For purposes of illustration, the incident beam is assumed to lie in the x-z plane, and the target surface is assumed to be a plane perpendicular to the z-axis. Other orientations can be accommodated by suitable adjustments in the parameters.

FIG. 1A shows an incident light beam aimed at a location on the target surface when the surface is not being excited. This location is labeled O, and the angle of the beam relative to the z-axis is θ. This location is also referred to herein as a point of interest or an area of interest. Because the surface is not being disturbed, the z-axis is perpendicular to the planar surface and the angle of reflection is also θ, and so the reflected light beam is imaged on the image capture screen at a distance from the z-axis equal to tan θ*z₀.

FIGS. 1B and 1C illustrate what happens when the surface is perturbed by some external source. FIG. 1B presents a high level view of a light beam being reflected from a surface that is tilted and displaced from its original orientation and position by some externally induced vibration. The incident beam from a light source is aimed at a location on the target surface. This location is labeled O, and the angle of the beam relative to the z-axis is θ.

FIG. 1C gives a more detailed view of what happens in the region of the surface around O. The vibration is assumed to displace the surface in the z-direction by an amount, δ, and the surface angle from the x-axis is α. There can also be a deflection from the y-axis; this angle is labeled β. In the expressions that follow it will be the tangents of these angles that are used most often. These are abbreviated as follows: tan θ=H; tan α=A; tan β=B. Cotangents will also appear in places; these are simply the inverses of the tangents: cot θ=1/tan θ=1/H, etc.

The deflection from the x-axis means that the incident beam must travel a small additional distance in the x-direction, δx, before striking the target surface. It must also travel an additional distance beyond δ in the z-direction, labeled δ′. The total displacement in the z-direction is δ=δ+δ′. The following equations are based on FIGS. 1A, 1B, and 1C:

δ=tan α*δx (1)

δx=δ/(cot θ−tan α); (2)

cot θ*δx=δ+δ′=δ+tan α*δx=δz; (3)

δz=[1+tan α/(cot θ−tan α)]*δ; (4)

Using the abbreviations for tangents and the trigonometric identities described above, these equations can be summarized as:

δx=δ*[H/(1−AH)];

δz=δ/(1−AH);

The angle at which the incident light beam strikes the surface is θ+α, and so this is also the angle of reflection of the light beam toward the image capture screen 18. From the diagram in FIGS. 1B and 1C it can be seen that the angle of the reflected beam relative to the z-axis is θ+2α. Together with the values of δx and δz, this determines the location at which the reflected beam strikes the image capture screen.

The distance in the z-direction from the undisturbed target surface to the image capture screen is designated as z₀. The position of the image formed by the reflected beam on the surface of the image capture screen will be labeled with x and y coordinates, x_{d} and y_{d}, measured from the point at which the z-axis intersects the image capture screen. When the target surface is not excited (i.e., no displacement and no change in the surface angle), the distance of the reflected image on the surface of the image capture screen from the z-axis in the in the x-direction would be simply x_{d}=H*z₀; because the incident beam is assumed to lie in the x-z plane and y_{d} remains at zero.

When the surface is excited, the displacements in the x and z directions, δx and δz, and the changes in the surface angle from the x and y axes, α and β, must be taken into account:

z₀=>z₀+δ_{z};

x_{d}=δx+[(H+2A−A²H)/(1-2HA−A²)]*(z₀+δ_{z});

y_{d}=[2B/(1−B²)]*(z₀+δ_{z});

These expressions make use of the abbreviations for tangents and the trigonometric identities described above.

In general, the displacements, x_{d}, and y_{d}, depend on the quantities, δz, δx, δy, H, A, B, and others defined above. When all relevant factors are taken into account, the result is a rather complicated cubic equation. However, the most important dependence, by far, is on the angles at which the target surface is deflected from its unexcited state by the external excitations. These angles are represented in the equations by their tangents, A and B. Because of this, only the largest linear terms contribute significantly to the relevant calculations. The resulting equations are:

A=δx_{d}/2z₀and B=δy_{d}/2z₀.

This can be shown in detail as follows. When the expanded expressions for δx and δz shown earlier are inserted into the equations for x_{d} and y_{d} the equations for those terms (which are directly measured) become:

x_{d}=δ*[H/(1−AH)]+[(H+2A−A²H)/(1−2HA−A²)]*[z₀+δ/(1−AH)];

y_{d}=[2B/(1−B²)]*[z₀+δ/(1−AH)];
What is of primary interest is the change in these values during excitation:

δx_{d}=δ*[H/(1−AH)]+[(H+2A−A²H)/(1−2HA−A²)]*δ/(1−AH)]+z₀[(H+2A−A²)/(1−2HA−A²)−H];

δy_{d}=[2B/(1−B²)]*[z₀+δ/(1−AH)];

The expression for 5x_{d} can be rearranged as:

δx_{d}=δ*[(2H+2A(1−H²)−A²)(1+H)]/[(1−3HA+A²(2H²−1)+HA³]+z₀[(2A(1+H²)−A²(1+H)/(1−3HA+A²(2H²−1)+HA³)];

The quantities of interest in these equations are the z displacement, δ, and the changes in the surface angle represented by the tangent abbreviations, A and B. Although the cubic equation is very complicated, the information of interest can be extracted by noting the relative magnitude of the terms involved. The values of H and z₀ are chosen to optimize the acquisition of the relevant data. H will typically correspond to a fairly small angle and z₀ will usually be set at a substantial standoff distance, such as one meter. The displacement in the z direction, δ, is ordinarily very small. The surface angles are also rather small. Since z₀ is much greater than δ, the value of δx_{d} is determined almost entirely by the terms multiplying z₀. All of the terms except for 2A can be neglected since they are quadratic or cubic in small quantities. Hence the value of A is given accurately by: A=δx_{d}/2z₀. Similarly, the tangent of the surface angle from the y-axis is given by B=δy_{d}/2z₀.

Vibrations propagating across the surface typically induce some deformation and curvature of the surface from its original orientation, and this results in variations in the tangent to the surface at different locations. This situation is illustrated in FIG. 2A. The variation of the tangents provides a way to calculate the displacement of the surface in the z direction. This displacement, δ, can be determined by illuminating nearby points with slightly different x and y coordinates. Tangents for the surface angles can be determined in the same manner. The tangents for the two different illuminated spots can be labeled A₁, B₁, A₂, B₂, and the differences in the x and y coordinates for the two illuminated points on the target surface can be labeled Δx and Δy. By tracking the motion over time, the frequency (and period) of the oscillations can be determined. The maximum and minimum values for A₁, B₁, A₂, B₂, (ΔAₘₐₓ=A₁ₘₐₓ−A₁ₘᵢₙ, ΔBₘₐₓ=B₁ₘₐₓ−B₁ₘᵢₙ) over each period can also be tracked. The variations in the positions of the two illuminated spots on the image capture screen 18 are illustrated in FIG. 2B.

For a single wave propagating in the x-direction, the wavelength, λx, of the vibrations propagating across the surface can be determined from these quantities:

arcsin(A₁/ΔAₘₐₓ)−arcsin(A₂/ΔAₘₐₓ)=2*π*Δx/λₓ→λₓ=2*π*Δx/[arcsin(A₁/ΔAₘₐₓ)−arcsin(A₂/ΔAₘₐₓ)].

For a single wave propagating in the y-direction the wavelength, λ_{y}, the equation becomes:

arcsin(B₁/ΔBₘₐₓ)−arcsin(B₂/ΔBₘₐₓ)=2*π*Δy/λ_{y}→2*π*λ_{y}=Δ_{y}/[arcsin(B₁/ΔBₘₐₓ)−arcsin(B₂/ΔBₘₐₓ)].

For a single wave propagating in the x-direction the displacement in the z-direction is given by: δ=(ΔAₘₐₓ*λₓ)/(2*π). For a single wave propagating in an arbitrary direction, it is necessary to perform a vector addition both on the tangents, Aₘₐₓ and Bₘₐₓ, and on the wavelengths, λₓ and λ_{y}. These are done in the usual way by applying the Pythagorean theorem. The value of z-displacement can then be determined using the resulting values for wavelength and maximum tangent by applying the formula described for propagation in the x-direction. The speed of the waves is determined by multiplying the wavelength by the frequency: v=λ*f. Maximum acceleration of the surface in the z-direction is calculated by multiplying the maximum displacement by the squared angular frequency: accel=δₘₐₓ*ω² where ω=2*π*f.

Primary concerns of the manufacturers of the structures being investigated include large shear forces experienced by the structure. These occur when nearby portions of the structure are subject to large forces in opposite directions at the same time. The shear can be determined from calculations described above by dividing the maximum acceleration by one half the wavelength: 2*accel/λ. The frequency provides a measure of how often a region is subject to the shear.

The direction of wave propagation is indicated by the direction of the tangent as determined by vector addition of A and B. For waves propagating in multiple directions this direction will change over time and there will be different maxima for different wave directions. The number of distinctly different tangent maxima corresponds to the number of distinct major wave modes. In general, there is a different amplitude, δₘₐₓ, associated with each wave mode. These can be labeled δ1ₘₐₓ, δ2ₘₐₓ, δ3ₘₐₓ, etc.

Phase relationships between the largest maxima can be determined by comparing the frequencies at which they occur. To determine the displacement in the z-direction that results from the different interfering wave modes, these phase relationships must be taken into account:

δ=δ1ₘₐₓ*cos(Ω1+ω1*t)+δ2ₘₐₓ*cos(Ω2+ω2*t)+δ3ₘₐₓ*cos(Ω3+ω3*t).

Ω1, Ω2, Ω3 are phase angles, which, in general, are different for different wave modes.

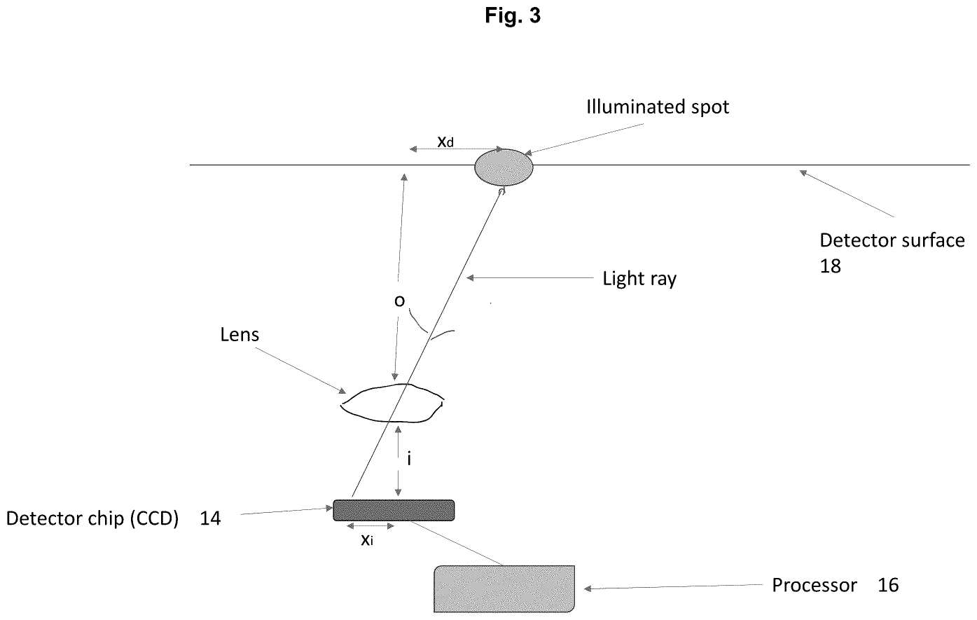

FIG. 3 illustrates the way in which position and changes in position of the image (x_{d}, δx_{d}, y_{d}, δy_{d}) of the reflected beam on the image capture screen are determined by active optical triangulation. The figure shows how the position of the illuminated spot on the image capture screen determines the location of the image on the detector. It is clear from the illustration how a change in position of the spot on the image capture screen results in a change in the location of the image on the chip. The angle of the light rays from the spot that pass through the lens changes as the spot moves; the image of the spot on the detector changes as a result. The x-coordinate of the spot, x_{d}, is determined by the specific geometric relationship between the image capture screen, lens and chip. In the simplest cases the following equation can be used:

x_{d}/O=−xᵢ/i

x_{d}=−xᵢ*O/i.

In this expression x_{d} refers to the x-coordinate of the location of the illuminated spot on the image capture screen; o is the perpendicular distance from the second surface to center of the lens; xᵢ refers to the x-coordinate of the image of the illuminated spot on the detector; i refers to the distance of the image on the detector from the lens. The image distance, i, is approximately equal to the focal length of the lens.

The distance in the x-direction between the location of the spot on the image capture screen at the time, t, and the equilibrium position of the spot is determined by subtracting x_{d0} from x_{d}(t): δx_{d}=x_{d}(t)−x_{d0}. The measurements of and calculations for y_{d} and δy_{d} are done in the same way as discussed above. In most implementations, a second light source is aimed at a nearby spot on the target surface and the image of the reflected beam on the image capture screen is tracked in the manner just described. These y-direction measurements can be made by the same detection apparatus or by a companion apparatus, depending on the characteristics of the detector. It is understood that additional light sources and observation devices could be used to obtain additional relevant information regarding the motion of the target surface. To perform the calculations described above, the light detector 14 is interfaced with a processor 16. The processor 16 determines a change in position of the image of the reflected light detected by the detector. It is also readily understood that optical triangulation is a very general method for determining angles and distances and that, therefore, viewing angles, distances and apparatus configurations can changed in a manner that is best adapted to the application.

In one example, the processor 16 is implemented as a microcontroller. It should be understood that the functions performed by the processor can be implemented in hardware logic, software logic, or a combination of hardware and software logic. In this regard, processor 16 can be or can include any of a digital signal processor (DSP), microprocessor, microcontroller, or other programmable device which are programmed with software implementing the above described methods. It should be understood that alternatively the processor is or includes other logic devices, such as a Field Programmable Gate Array (FPGA), a complex programmable logic device (CPLD), or application specific integrated circuit (ASIC). When it is stated that processor 16 performs a function or is configured to perform a function, it should be understood that processor 16 is configured to do so with appropriate logic (such as in software, logic devices, or a combination thereof).

Prior to dynamic testing, the characteristics of the target surface in the region of interest can be investigated by altering the position and orientation of the observing system with appropriate actuators and recording the measurements and calculations described above. The characteristics include variations in the angle of the target surface due to curvature or other factors, reflectivity of the surface and variations of the reflectivity of the surface. Reflectivity is measured by variations in received light intensity by the detectors taking into account the orientation of the surface. The results of such a preliminary surface can be used both to characterize the surface and to adjust calculations made during dynamic testing.

Because the systems and methods described herein provide a means to acquire very precise information about the characteristics and dynamic behavior of the surface, it can be desirable to apply them even in cases in which the target surface is not highly reflective. In these cases, a highly reflective coating, for example in the form of paint, a decal or other means can be applied to the target surface in regions of interest.

The non-contact approach described above does not affect the physical and acoustical behavior of the surface of the object. Furthermore, this approach is unsusceptible to high temperatures, high temperature gradient, and exposure to extreme electrostatic and electromagnetic interference.

To observe dynamic change in topography of the surface in three degrees of freedom, the non-contact measurement technique preferably includes multiple emitter/detector pairs; the incident and reflected light beams from multiple (2) emitter-detector pairs are illustrated in FIGS. 2A and 2B. Measurements by each light detector may be triggered concurrently, for example by a reference clock signal. For synchronization, each measurement is tagged with a precise time stamp by the processor. To ensure accurate correspondence between emitter/detector pairs, intensity of the light emitted from the light sources may be modulated with different pre-defined patterns of frequency variation.

Multiple emitter/detector arrangements of the kind described above could be used to observe disturbances at multiple locations on the target surface. By measuring and computing the wave characteristics described above over time, one can generate a times series of relevant values and determine a vector representing a wave propagating along the surface of the object at the point of interest.

From the displacement measurements, the frequency of oscillations at the observation point can also be calculated by performing a Fourier analysis of the sequence of displacements, dz, over an appropriate interval of time. The appropriate time interval for measuring the sequence of displacement measurements depends on the sampling rate and the anticipated frequency of the oscillations. For illustration purposes, the structure is subjected to external excitations and displacement measurements for each emitter are made at high frequency, for example, 40 kilohertz. From the Nyquist sampling theorem this provides the necessary data to determine all frequencies up to one half the sampling frequency (for example, 20 kilohertz). The relative contributions of the dominant frequencies can be obtained by Fourier analysis. The dominant frequencies determine the specific time intervals over which to look for maximum displacements. For example, a frequency of 2 kilohertz implies time intervals of 500 microseconds (0.5 milliseconds). With a 40 kilohertz sample rate, this corresponds to a set of 20 consecutive measurements from each emitter. In other words, the maximum positive and negative deviations from the equilibrium position are determined from a set of 20 consecutive samples. The “dominant” frequencies are those which contain the greatest amount of energy, where the energy in the signal is determined by the square of the amplitude and the set of dominant frequencies would include those frequencies that that jointly contain a large fraction of the total energy (e.g., 90% of the total energy). All frequencies up to one half of the sampling rate (for example, 44 kilohertz) can be determined in this way through discrete Fourier transforms.

Prior to any testing, a 3-dimensional model of the surface could provide an estimate of the signals that would be received at each test location. It could also provide the basis for an algorithm that would predict the variation in the signals in response to various disturbances. Prior to an active test in which various external forces would be applied to the surface, a not excited survey could be conducted by moving the emitter-detector arrangement in several different ways. The arrangement described above could be moved slowly by some appropriate actuator(s). Small movements toward and away from the target surface, along with movements in the other two dimensions, would enable one to determine the alteration in the signals that would occur with high-frequency disturbances of the surface. Small rotations of the apparatus would provide information about the effect that changes in the angle of the surface would have on the received signals. Essentially, these tests while the surface remains not excited would provide a “slow-motion” version of what to expect during a dynamic test. The information gathered in this way could be compared to the 3-dimensional model, and used to develop (or refine) a tracking algorithm that would predict how the pattern of illumination would move across the detector in response to various disturbances. This algorithm would be used to achieve a sufficiently high sample rate by indicating which subset of pixels should be selected in the next sampling time.

In one aspect of this disclosure, a system may be constructed for measuring vibrations on a surface of an object, where the system is comprised of one or more observation devices. The observation device is supported above the point of interest on the surface of an object by a support mechanism. As noted above, the light sources and the light detectors are housed by the observation device are arranged in a geometric plane that is substantially parallel to the surface of the object. The geometric plane serves as the xy plane of a Cartesian coordinate system; whereas, an imaginary line drawn from the point of interest to the geometric plane serves as the z axis of the Cartesian coordinate system. For calibration purposes, the support mechanism is configured to adjust the position of the observation device in relation to the surface of the object along five degrees of freedom. That is, position of the observation device can be rotated around the x axis, rotated around the y axis or translated along any of the three axis of the Cartesian coordinate system. It is envisioned that the position of the observation device can be adjusted manually by an operator or in an automated manner, for example using servo motors. Suitable support mechanisms are readily found in the art. A graphical interface may be used to assist with positioning of the observation device. The graphical interface operates to display current observed position and orientation of the observation device relative to the point of interest on the surface as well as a priori CAD models of the surface. Observing the graphical interface, an operator can adjust the observation device accordingly.

An example calibration and set-up procedure for an observation device is further described. First, establish the correct vertical (z) and planar (X-Y) orientation of a given observation device in order to aim the focal point of the observation device onto the point of interest on the surface under investigation. To do so, adjust the support mechanism to achieve X and Y orientation of the base plane of the observation device in order that it would be parallel to the X-Y plane (or perpendicular as derived from average of the slopes in the case of observing an acutely peaked at it's zenith) of the surface at the point of interest, for example by manipulating the supporting fixture orientation-adjustment mechanisms. After completing this step, adjust the distance along the vertical z axis between the base plane of the observation device and that of the surface at the point of interest, for example by means of a rack-and-pinion gear-set. Drawing upon the surface topography provided by 3-D renderings, such as CAD, photogrammetric files or high-resolution photographic images, the operator can make judgements for the selection of the desired point of interest on the surface.

To observe and quantify the effect of undesired external (uncontrolled) sources of mechanical excitation acting upon the surface under investigation, one can initiate projection of light from the light sources at a defined level of intensity onto the surface under investigation at the desired point of interest, in order to accurately quantify what, if any acoustic excitation is being conveyed onto the surface by uncontrolled external forces. In the course of this stationary characterization procedure, the frequency content, amplitude, and velocity of such external excitation is quantified.

To quantify the effect of undesired external (uncontrolled) sources of illumination that may interfere with correct observation by the light detectors, one can initiate projection of light from the light sources at a defined level of intensity onto the surface under investigation. To determine the effects of any stray light at the desired point of interest, compare the detected level of illumination received by each of the light detectors in the observation device by subtracting the level of projected illumination from each of the light sources.

In some embodiment, the system for measuring vibration on a surface of an object is comprised of a plurality of observation devices arranged spatially apart from each other and above the surface of the object. Each observation device is configured to interrogate a different point of interest on the surface of the object.

To coordinate reporting from the plurality of observation devices, each observation device is in data communication (or interfaced) with a central computing device. More specifically, each observation device is configured to receive the same reference clock signal from the central computing device. The reference clock signal serves as a trigger for the light detectors residing in a given observation device to acquire light measurements. Each observation device also includes at least one QR code or another type of unique identifier which can be used to uniquely identify the given observation device in the plurality of observation devices.

Additionally, the position of each observation device in a common coordinate system is also known by the central computing device. For instance, the position of an observation device may be known a prior from CAD data and/or other design documents. Alternatively, the position of each observation device in the common coordinate system may be determined using an independent camera system. Other techniques for determining the position of the observation devices in relation to each other and/or to a common coordinate system are known in the art.

Data from two or more of the observation devices can in turn be used to quantify other metrics related to vibrations experienced by the surface of the object. For example, the speed of a wave propagating between and observed by two observation devices can be computed. Knowing the distance between two observation devices, speed of a propagating wave is determined by dividing this distance by the time it takes the wave to propagate between the two observation devices. This simplified example assumes the wave is propagating along a straight line connecting the two observation devices.

A display device may be interface with the processor. During an investigation, a priori CAD or photographical representation of the surface can be displayed on to the display. Metrics related to vibrations experienced by the surface of the object and observed by the system can also be displayed on the display device. In some embodiments, vibrations, including the different propagating waves, experienced by the surface are animated or otherwise visualized (e.g., using a waterfall illustration) on a graphical user interface.

The computational and measurement techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A non-contact method for measuring vibrations on a highly reflective surface of an object, comprising:
projecting, by a light source, beam of light towards an area of interest on a surface of an object;
receiving, by an image capture screen, the light reflected by the area of interest on the surface of the object, where the image capture screen is configured to diffuse the light incident thereon;
capturing, by a detector, an image of the light on the image capture screen;
determining, by a processor, change in position of the image on the detector over time, where the processor is interfaced with the detector; and
calculating, by the processor, a series of changes in the surface angle and a series of vertical displacements of the surface from the change in position of the image and using triangulation.

2. The method of claim 1 wherein further comprises determining a characteristic of a wave propagating along the surface of the object using the series of changes in the surface angle and the series of vertical displacements.

3. The method of claim 2 wherein the characteristic of the wave is selected from a group consisting of a direction, a wavelength, an amplitude, a frequency or an induced shear strain of the wave propagating along the surface.

4. The method of claim 1 wherein the image capture screen is one of reflective or translucent.

5. The method of claim 1 wherein the series of changes in the surface angle are calculated according to: A=δx_{d}/2z₀ and B=δy_{d}/2z₀,
where the x axis and the y axis define a plane which is parallel to the surface of the object; A and B are tangents of the angles of deviation in the x and y directions respectively; z₀, is distance between the surface of the object when not excited and the image capture screen; and δx_{d} and δy_{d} are changes in position of the image differences in x and y directions from its equilibrium location.

6. The method of claim 2 further comprises determining frequency of the wave propagating along the surface by measuring time between successive measurements of maxima of the tangents of the changes in the surface angle in the x and y directions; or by performing a Fourier analysis on the series of measurements of changes in the surface angle.

7. The method of claim 6 further comprises calculating wavelength of the wave propagating along the surface using difference between measurements of the tangents of the changes in the surface angle at two points of observation.

8. The method of claim 7 further comprises calculating speed of the wave propagating along the surface by multiplying the wavelength of the wave by the frequency of the wave.

9. The method of claim 7 further comprises calculating amplitude of the wave propagating along the surface using the wavelength of the wave propagating along the surface and tangent of the changes in the surface angle.

10. The method of claim 7 further comprises determining direction of wave propagating across the surface by vector addition of tangents of surface angle in two non-parallel directions in a plane which is parallel to the surface of the object.

11. The method of claim 1 wherein the light source is further defined as a laser.

12. The method of claim 1 where said detector or detectors is further defined as a charge-coupled device or a CMOS device.

13. The method of claim 1 wherein the detectors detects light reflected by the surface at more than 40,000 frames per second.

14. A non-contact method for measuring vibration on a surface of an object, comprising:
projecting light from two or more light sources towards a point of interest on a surface of an object, where the light projected from the two of more light sources is coherent;
receiving the light reflected by the point of interest on an image capture screen, where the image capture screen is configured to diffuse the light incident thereon;
capturing an image of light on the image capture screen using two or more detectors, where each detector of the two or more detectors captures light from a corresponding one of the two or more light sources;
from the light captured by the two or more detectors, determining, by a processor, change in position of the image on each detector over time, where the processor is interfaced with each of the two or more detectors;
from the change in position of the image on each detector of the two or more detectors, calculating, by the processor, a series of deflection angles of the surface at the point of intertest about an x axis using triangulation; and
from the change in position of the image on each detector of the two or more detectors, calculating, by the processor, a series of deflection angles of the surface at the point of interest about y axis using triangulation, where the x axis and the y axis define a plane which is parallel to surface of the object.

15. The method of claim 14 wherein further comprises determining a characteristic of a wave propagating along the surface of the object using the series of deflection angles about the x axis and the series of deflection angles about the y axis.

16. The method of claim 15 wherein the characteristic of the wave is selected from a group consisting of a direction, a wavelength, an amplitude, a frequency or an induced shear strain of the wave propagating along the surface.

17. The method of claim 14 wherein the image capture screen is one of reflective or translucent.

18. The method of claim 14 wherein the series of deflection angles are calculated according to: A=δx_{d}/2z₀ and B=δy_{d}/2z₀,
where the x axis and the y axis define a plane which is parallel to the surface of the object; A and B are tangents of the deflection angles in the x and y directions, respectively; z₀, is distance between the surface of the object when not excited and the image capture screen; and δx_{d} and δy_{d} are changes in position of the image differences in x and y directions from its equilibrium location.

19. The method of claim 15 further comprises determining frequency of the wave propagating along the surface by measuring time between successive measurements of maxima of the tangents of the deflection angles in the x and y directions.

20. The method of claim 19 further comprises calculating wavelength of the wave propagating along the surface using difference between measurements of the tangents of the deflection angles at two points of observation.

21. The method of claim 20 further comprises calculating speed of the wave propagating along the surface by multiplying the wavelength of the wave by the frequency of the wave.

22. The method of claim 20 further comprises calculating amplitude of the wave propagating along the surface using the wavelength of the wave propagating along the surface and tangent of the deflection angle.

23. The method of claim 20 further comprises determining direction of wave propagating across the surface by vector addition of tangents of deflection angles in two non-parallel directions in a plane which is parallel to the surface of the object.

24. A non-contact method for measuring vibration on a surface of an object, comprising:
projecting light from two or more light sources towards an area of interest on a surface of an object, where the light projected from the two of more light sources is directed towards at least two points of interest on the surface of the object;
receiving the light reflected by the at least two points of interest on an image capture screen, where the image capture screen is configured to diffuse the light incident thereon;
capturing an image of light on the image capture screen using two or more detectors, where each detector of the two or more detectors captures light from a corresponding one of the two or more light sources;
for each of the at least two points of interest, determining, by a processor, change in position of the image from the light captured by each detector over time, where the processor is interfaced with each of the two or more detectors;
from the change in position of the image on each detector of the two or more detectors, calculating, by the processor, a series of deflection angles of the surface at each of the at least two points of intertest about an x axis using triangulation; and
from the change in position of the image on each detector of the two or more detectors, calculating, by the processor, a series of deflection angles of the surface at each of the at least two points of interest about y axis using triangulation, where the x axis and the y axis define a plane which is parallel to surface of the object.
